(19) United States
(12) Patent Application Publication
(10) Pub. No.: US 2026/0161977 A1
(43) Pub. Date: Jun. 11, 2026

(54) SYSTEMS AND METHODS FOR LARGE LANGUAGE MODEL TEXT GENERATION EXPLAINABILITY

(71) Applicant: WELLS FARGO BANK, N.A., San Francisco, CA (US)

(72) Inventors: Ying Li, Sunnyvale, CA (US); Anwesha Bhattacharyya, Gaithersburg, MD (US); Rahul Singh, Charlotte, NC (US); Tarun Joshi, Forest Hills, NY (US); Keqiao Li, Charlotte, NC (US)

(21) Appl. No.: 19/388,099

(22) Filed: Nov. 13, 2025

Related U.S. Application Data
(60) Provisional application No. 63/730,796, filed on Dec. 11, 2024.

(51) Int. Cl. G06N 5/045; G06F 16/34

(52) U.S. Cl. CPC G06N 5/045; G06F 16/345

(57) ABSTRACT

In some examples, a method is described. The method includes receiving a prompt including a set of input elements and applying the input prompt to a large language model to generate a summary comprising a set of generated elements. A target element within the set of generated elements can be identified, and a similarity score determined for each input element. The similarity score can represent a strength of similarity between the input element and the target element. The method includes identifying sets of candidate contributor elements among the input elements based on the similarity score for each input element of the set of input elements. A reduced prompt can then be generated. The method includes applying the reduced prompt to the LLM to generate a second summary comprising a second set of generated elements. The method can then include identifying candidate contributor elements.

### CROSS-REFERENCE TO RELATED APPLICATIONS

This application claims priority to U.S. Provisional Patent Application No. 63/730,796, filed on Dec. 11, 2024, and entitled “SYSTEMS AND METHODS FOR LARGE LANGUAGE MODEL TEXT GENERATION EXPLAINABILITY,” the entirety of which is hereby incorporated by reference herein.

### FIELD OF INVENTION

The present disclosure generally relates to large language models, and more specifically to systems and methods for large language model text generation explainability.

### BACKGROUND

Large Language Models (LLMs) represent an intersection of artificial intelligence (AI) and natural language processing (NLP) techniques that have garnered increasing interest due to the advent of machine learning (ML) technologies. LLMs are able to comprehend input received from users and generate processed output, rendering LLMs a highly valuable tool across various industries. LLMs have been applied in a variety of contexts including use as chatbots, translation tools, education tools and search systems among other relevant applications.

A current limitation within LLMs lies in LLMs' underlying machine learning structures. Machine learning structures, whether they be trained via supervised or unsupervised learning, and whether they have deep learning algorithmic structures or shallow learning algorithmic structures, all rely on weighted nodes to generate predictions (e.g., in the form of text for LLMs) based on various inputs. The statistical, node-based structure of LLMs and other ML applications renders the internal analysis of such applications hard to parse. Referred to as “black boxes”, LLMs and other ML models lack transparency and interpretability in how the models arrive at their decisions and predictions.

Attempts to improve LLM explainability have had limited success. Such approaches provide limited explainability, and such methods have required knowledge of the model architecture. Such approaches only work on smaller language models, such as GPT-2, and with very short text phrases (e.g., 10 words or fewer) in practice due to high computational cost and difficulty in aggregating results at higher levels, such as at the paragraph level. In other words, such models may have meaningful explainability for a given token or word, but when the phrases are aggregated (e.g., at or beyond 100 words), such models become ineffective and hard to interpret.

### SUMMARY

According to certain examples, a method is described. The method includes receiving a prompt including a set of input elements and applying the input prompt to a large language model (LLM) to generate a first summary comprising a set of generated elements. A target element within the set of generated elements can be identified, and a similarity score determined for each input element. The similarity score can represent a strength of similarity between the input element and the target element. The method further includes identifying a set of candidate contributor elements among the set of input elements based on the similarity score for each input element of the set of input elements. A reduced prompt is generated including a subset of the input elements lacking the set of candidate contributor elements. The method includes applying the reduced prompt to the LLM to generate a second summary comprising a set of second generated elements. In response to determining the second summary contradicts the target element, the method includes identifying one or more candidate contributor elements of the set of candidate contributor elements as contributor elements.

According to additional examples, an iterative method is described. The iterative method includes, for each candidate contributor, generating a size 1 test prompt, where the size 1 test prompt includes each input element except the candidate contributor. For each size 1 test prompt, the iterative method can include generating a corresponding summary and determining whether the corresponding summary contradicts the target element. In response to determining the corresponding summary contradicts a target element, the iterative method includes identifying the respective candidate contributor as a contributor element. The method then iterates by generating candidate contributor pairs for each remaining candidate contributor. For each candidate contributor pair, the iterative method generates a size 2 test prompt, where the size 2 test prompt includes each input element except the candidate contributor pair. For each size 2 test prompt, the iterative method includes generating a corresponding summary and determining whether the corresponding summary contradicts the target element. In response to determining the corresponding summary contradicts the target element, the iterative method includes identifying the respective candidate contributor pair as a contributor pair. According to some examples, the iterative method may continue by increasing the test prompt size until the test prompt size is greater than the number of remaining candidate contributors.

Certain aspects of the present disclosure involve systems and non-transitory computer-readable mediums having instructions stored thereon for executing the above described methods.

These illustrative aspects are mentioned not to limit or define the disclosure, but to provide examples to aid understanding thereof. Additional aspects are discussed in the Detailed Description, and further description is provided there.

### BRIEF DESCRIPTION

A full and enabling disclosure is set forth more particularly in the remainder of the specification. The specification makes reference to the following appended figures.

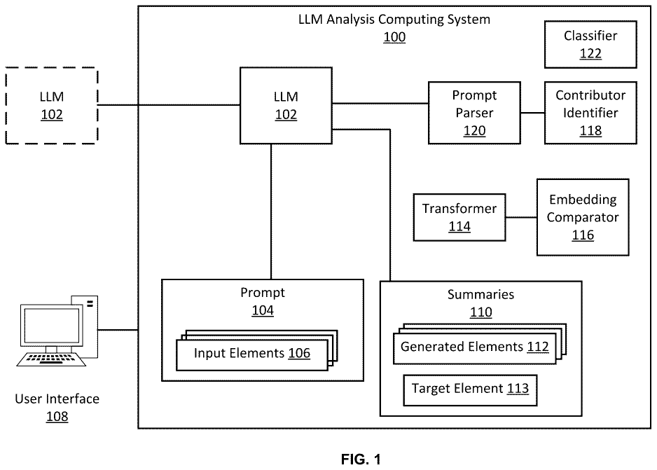

FIG. 1 illustrates a system for analyzing LLM inputs and outputs, according to certain examples.

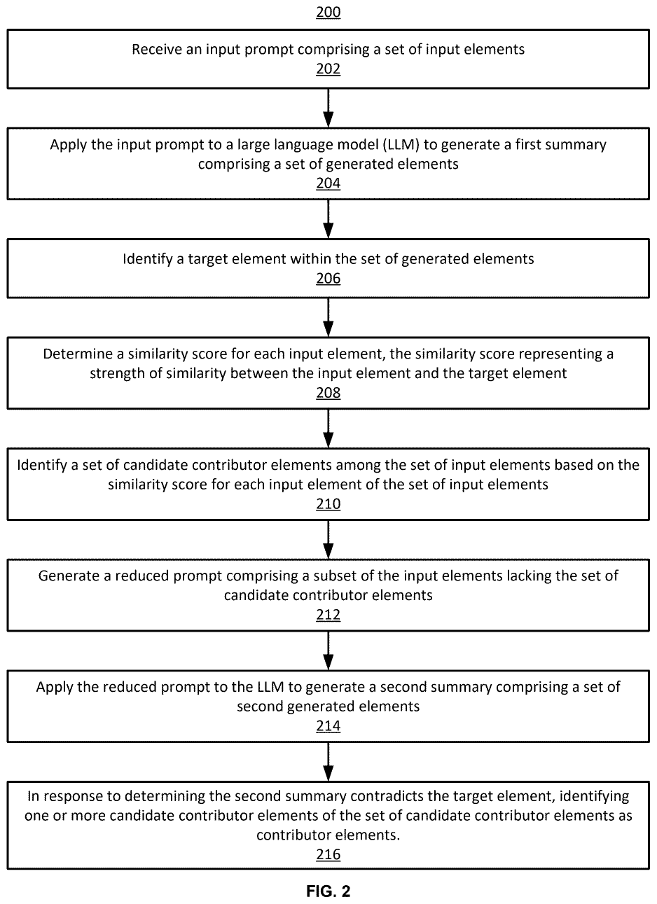

FIG. 2 shows an example process for explaining LLM output based on identifying contributor inputs, according to certain examples.

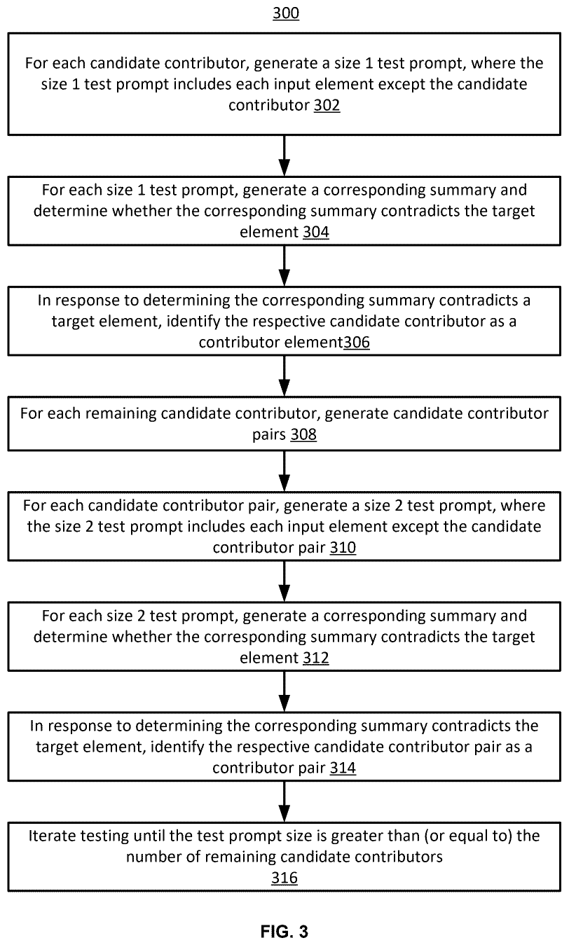

FIG. 3 shows an example process for denoising contributor inputs to improve LLM explainability, according to certain examples.

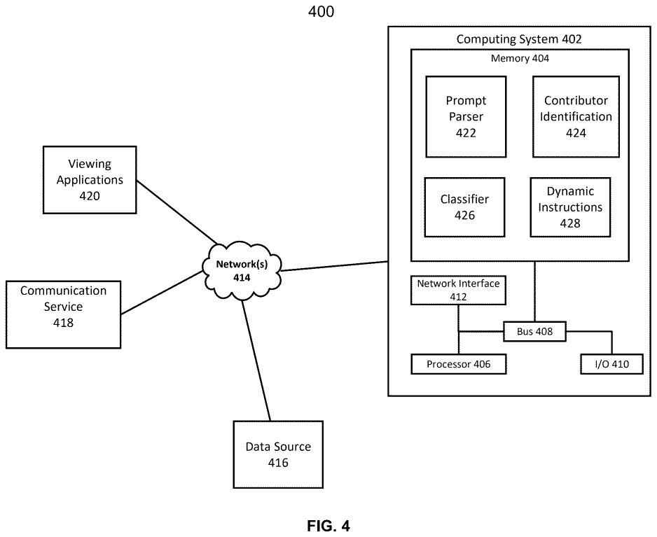

FIG. 4 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of any appended claims and their equivalents.

### Illustrative Example of an LLM Explainability System

In one illustrative example, an LLM explainability system is described, providing practical and useful techniques for explaining LLM text generation tasks by understanding what the LLM is “thinking” based on its underlying architecture and training. The LLM explainability system can analyze the determinations and predictions of a given LLM through a perturbation process of manipulating input prompts to determine how the LLM generates output text. In other words, the described explainability systems and methods can explain what factors cause an LLM to generate a given output.

The described LLM explainability system provides several advantages over previous attempts to explain LLM functionality. For instance, the described LLM explainability system is model agnostic—there are no restrictions on the LLM used, and there is no need to know the model architecture details such as through token level analysis. Instead, all that is necessary is the ability to call the LLM by providing input prompts. Requiring access to LLM architecture details also prevents analysis of closed source models. Thus, the LLM explainability system is capable of being implemented across a variety of LLM architectures such as Generative Pre-Trained Transformers (GPT-3, GPT-4, etc.), Meta Llama, and the like. Moreover, the model agnostic features of the LLM explainability system allow for determining LLM functionality regardless of whether the system has access to the underlying architecture of the LLM (e.g., whether the LLM is a private model with closed source code).

The described LLM explainability system provides further advantages over previous attempts to explain LLMs by allowing for the explanation of longer, harder to parse text more efficiently with strong performance in practical real-world data and implementation. Previous explainability models are only capable of working on smaller language models, such as GPT-2, and with very short amounts of text (e.g., 10 words or less) given the difficulty of aggregating results as the amount of text increases. Such previous explainability models, while working in theory for longer textual data, are rendered ineffective when applied in practice. Such previous models become infeasible in implementation due to the exponential computational costs of processing larger sets of text. The described LLM explainability system can thus provide technical benefits in providing optimized techniques for explaining LLM operations, significantly reducing the number of operations required to explain the functionality of an LLM, thereby conserving computing resources such as memory utilization, computing time, energy expenditures, and the like.

### Illustrative Example of LLM Explainability System Operations

In an illustrative example of the operations underlying the LLM explainability system, the system can receive an input prompt (P) including a collection of text comprising several sentences (P₁, P₂, P₃, . . . Pₙ). The collection of text can be input into an LLM (e.g., Llama3) for generating a summary(S), where the summary S includes, for instance, a collection of sentences (S₁, S₂, S₃, . . . Sₘ) representing a condensed version of the prompt.

A goal of the LLM explainability system is to understand why the LLM is generating each sentence in the summary. Explaining why the LLM is generating each sentence can entail determining the specific sentences input into the LLM (referred to as “contributors”) which cause the LLM to generate a target sentence within the output summary. To achieve this goal, the target sentence (referred to as Sₜ where Sₜ is an element within S) can be selected from the summary S. The target sentence can be a particular sentence requiring analysis and explanation from the LLM, such as a hallucination. Additionally, multiple sentences can be included as multiple target sentences. It should be noted that while for the purposes of the illustrative example, the LLM explainability system relates to explaining target sentences produced by an output summary based on sentences within an input prompt, the same techniques are contemplated for other collections of strings. Thus, in some examples, the discussion relates to LLM summarization on a sentence level, the described techniques are not limited to the sentence level, and the discussed techniques can be used for words, phrases, and paragraph levels according to a variety of implementations.

To achieve explaining the target sentence through identified contributors, a pre-trained sentence transformer can be used to produce the sentence embedding for each sentence P₁, P₂, P₃, . . . Pₙ within the prompt P used to generate the summary S, in addition to the sentence embedding for the target sentence Sₜ. A similarity score may be generated for each sentence embedding based on the sentence embedding's proximity, or semantic similarity, to the target sentence. The similarity score can be derived from any embedding comparator function, such as a cosine similarity function, dot product, Euclidean distance, and the like. The sentences P₁, P₂, P₃, . . . Pₙ may then be ranked according to the semantic similarity with the target sentence Sₜ to be explained.

Candidate contributors may be used to determine the final set of contributors for a given output sentence. The candidate contributors include the full set of, or subset of, the sentences within the input prompt P. The size of the candidate contributor set determines the search range. For instance, the candidate contributors can be identified as the top three semantically similar sentences to the target sentence from within the prompt input P. Once defined and selected, the candidate contributors can methodically be removed from the input prompt to generate a reduced prompt, which is then input into the LLM to test the validity of the candidate contributors. Inputting the reduced prompt (definitionally lacking one or more of the candidate contributors) into the LLM produces a second summary (S′). S′ may then be evaluated to determine whether S′ contradicts the summary S having the target sentence Sₜ. Determining that S′ contradicts the summary S having Sₜ supports the conclusion that the candidate contributors should be included within the final set of contributors.

To perform the contradiction determination, a Natural Language Inference (NLI) classification model can be used to evaluate the similarity between S′ and the target sentence Sₜ within S. The NLI classification model can provide Zero Shot text classification. Zero Shot text classification operates on two parameters—a premise and a hypothesis. The hypothesis is classified as an entailment or a contradiction based on an evaluated probability. For instance, a premise could be “I want to have a trip abroad”, where the hypothesis is “This is a text about travel”. The predicted probabilities for entailments or contradictions can then be generated. The NLI classification model, capable of generating predicted probabilities of entailment or contradiction, provides a useful metric for determining contradictions between portions of text (e.g., providing scores to compare against thresholds used to classify the presence of a contradiction).

In the context of the LLM explainability system, the second summary S′, generated by the reduced prompt input into the LLM, is used as the premise and the target sentence Sₜ from S is used as the hypothesis. Thus, if the NLI model classifier identifies a contradiction, the contradiction would indicate that the second summary S′ no longer retains the target sentence Sₜ within the second summary's set of sentences. Absence of Sₜ from the reduced summary may then be deemed to have been caused by the lack of the candidate contributor under test. The absence of the candidate contributors, determined to cause the contradiction, would thus indicate the candidate contributors as a potential set of identified contributors. A range for explaining the target sentence Sₜ can then be defined as the set of identified contributors.

Additionally, or alternatively, if using the second summary S′ as a premise and Sₜ as a hypothesis, the NLI classifier identifies an entailment, where the entailment classification would indicate that the LLM can still infer the target sentence Sₜ through the reduced prompt. In such instances, the size of the candidate contributor set can be increased by further removing candidate contributors from the reduced prompt before re-inputting the reduced prompt into the LLM. For instance, an initial candidate contributor set size can be formed by removing the top three most semantically similar sentences, determined by the embedding comparator, from the input prompt.

If this initial candidate contributor set fails to produce a contradiction in its corresponding LLM generated summary, the candidate contributor set can be increased by removing the next two most semantically similar sentences from the input prompt. The candidate contributor refinement process can be tuned according to the search efficiencies of the underlying computing system in addition to the requirements for precision.

In instances where reduced prompts input into the LLM fail to generate contradictions, potential root causes can include, at least: 1) the target sentence being very general such that several input sentences can be identified as contributors; 2) the sentence transformer processing the sentences does not work well enough to provide meaningful top similar sentences; or 3) the classifier model is failing to function properly.

### Illustrative Example of Denoising the Candidate Contributor Set

Whether any subset of the candidate contributor set is sufficient to explain why the LLM generates the target sentence still would need to be decided. For instance, based on the reduced prompt generating a contradiction still does not indicate absence of which of the candidate contributors, or combinations of candidate contributors, actually caused the contradiction. At the same time, the pretrained sentence transformer model and the NLI classifier are themselves pretrained on a large general corpus, which may introduce their own model biases and weaknesses, thereby introducing noise into the identified contributor set. Therefore, according to certain examples, a denoising process can be implemented to provide quality control and filtering of the candidate contributor set.

To denoise the candidate contributor set, combinations and permutations of sentences within the candidate contributor set can be removed from the input prompt to produce a reduced prompt. The reduced prompt can be input into the LLM to regenerate a test summary to determine whether there is a significant change (e.g., contradiction as described above) in the NLI classifier prediction. The process of denoising the candidate contributor set can follow an optimized order of combinations and permutations of removing candidate contributors from the candidate contributor set.

The optimized order can include first removing any one candidate contributor (e.g., sentence) from the prompt to generate the reduced prompt, then regenerating the test summary by inputting the reduced prompt into the LLM. If a contradiction is detected between the reduced prompt and the target sentence Sₜ, the candidate contributor is identified as a contributor. Identifying a candidate contributor as a contributor can thereby remove the identified contributor from the candidate contributor set. If an entailment is identified as opposed to a contradiction, the candidate contributor under test is determined not to be important (i.e., not actually a contributor) or requiring collaboration with another candidate contributor to produce the target element (e.g., a target term). The process may then iterate for each single candidate contributor within the set of candidate contributors such that each single candidate contributor is tested without dependency on any other candidate contributor. The testing either identifies the candidate contributor as a contributor (i.e., causing a contradiction), or as of undecided importance (i.e., causing an entailment). Identified contributors are removed from the candidate contributor set, while those of undecided importance are retained in the set of candidate contributors, and the process may continue where the target size is expanded to simultaneous testing of two or more candidate contributors.

After a target size of one candidate contributor is tested, the denoising process may further iterate to expand the target size to two candidate contributors where each permutation of two candidate contributors is removed from the prompt to generate the reduced prompt. The reduced prompt is then similarly tested for contradictions. Pairs of candidate contributors under test (i.e., removed from the reduced prompt tested for contradictions) may then be evaluated to determine whether the collaboration between the pair of candidate contributors causes a contradiction, thereby identifying the pair of candidate contributors as a pair of identified contributors. Otherwise, like the single identified contributors, the pairs of identified contributors are removed from the remaining candidate contributor set to further reduce the size of the set of candidate contributors.

The process may further iterate in a similar manner, where the target size of contributors is expanded (i.e., testing triplets of candidate contributors, quadruplets, and the like). However, as the process of testing for contributors in such manner relies on an increasing number of permutations, and increasing computer power, a termination condition can be established. One termination condition can include expanding the target size of candidate contributors until the target size of candidate contributors is greater than the number of undecided elements (i.e., remaining candidate contributors) left in the input prompt. Thus, when the termination condition is reached, the denoising procedure of iteratively testing an expanded size of candidate contributors can be terminated.

### Example Computing System for LLM Analysis

FIG. 1 illustrates a system for analyzing LLM inputs and outputs, according to certain examples. The examples according to FIG. 1 are shown to illustrate the logical and physical implementation of the LLM analysis computing system 100 according to certain examples. Other examples, however, are possible. For instance, certain components may be shown as distinct components to illustrate the progression of the data flow, while according to some examples, the physical implementation of such components may be implemented across the same device. It is to be appreciated that the examples according to FIG. 1 are provided for illustrative purposes. An LLM analysis computing system 100 is shown for performing LLM analysis and explaining, based on given inputs, how an LLM produced its outputs. Examples of implementations of the LLM analysis computing system 100 capable of implementing the described examples of FIG. 1 are discussed further with respect to the computing system of FIG. 4.

The LLM analysis computing system 100 is shown including an LLM. The LLM can include any large language model built on ML architecture and capable of receiving input text and generating output text. Examples of LLM 102 can include publicly available LLMs such as Generative Pre-Trained Transformers (GPT-3, GPT-4, etc.), Meta Llama, and the like. Additionally, LLM 102 can include private LLMs such as custom built LLMs 102 internal to a given computing network. LLM 102 is shown as internal to the LLM analysis computing system 100 and also connected to an LLM 102 external to the LLM analysis computing system 100. External LLM 102 is shown to indicate that the LLM 102 may be accessed across a network and may not be internal to the LLM analysis computing system 100, according to certain examples.

LLM 102 is shown receiving a prompt 104 including a set of input elements 106. Input elements can include collections of text such as words, phrases, sentences, paragraphs, and the like. For instance, each element in the set of input elements 106 can include a single sentence. The prompt 104 can include an input prompt as received via a user interface 108, or can include a modified prompt (e.g., as generated by prompt parser 120) where the set of input elements 106 is reduced by removing candidate contributors as identified by contributor identifier module 118.

Prompts 104 input into the LLM 102 can generate summaries 110. Summaries, like prompts 104 can include a set of elements, specifically generated elements 112 where the generated elements 112 similarly include collections of text such as words, phrases, sentences, paragraphs, and the like. Among the set of generated elements 112, the summaries 110 can include a target element 113. The target element 113 represents an element that requires explanation (i.e., a determination as to why the LLM 102 generated the target element 113 based on the input elements 106 input into the LLM 102). The target element 113 can be selected via the user interface. In a practical example, the target element can include a hallucination sentence, paragraph, or the like as identified by a user.

The LLM analysis computing system 100 is shown including a transformer 114 coupled to an embedding comparator 116. The transformer 114 can be any pre-trained element transformer such as a word transformer, sentence transformer, paragraph transformer and the like. The transformer 114 is able to convert both input elements 106 and generated elements 112 (including the target element) into embedding representations to facilitate semantic similarity analysis applied by the embedding comparator 116. The embedding comparator 116 can be any similarity function capable of determining the similarity between embeddings. For instance, the embedding comparator 116 can include a cosine similarity function used to determine the semantic similarity of the input elements 106 (based on their embedding representation) to the target element among the set of generated elements 112. The similarities between each input element of the set of input elements 106 and the target element among the set of generated elements can be represented in the form of a similarity score.

The LLM analysis computing system is shown to further include a contributor identifier module 118 and prompt parser 120. The contributor identifier module 118 can include logic for determining elements within the set of input elements 106 that are likely to contribute to the generation of the target element 113 within the set of generated elements 112. For instance, the contributor identifier 118 can in a first instance, determine candidate contributors among the input elements 106 based on similarity scores generated by the embedding comparator 116. For instance, the contributor identifier 118 may be configured to identify a set of candidate contributors by ranking the set of input elements 106 by descending order of similarity scores to the target element. The size of the candidate contributor set can be tuned, for instance, by a user via the user interface 108. Thus, in some examples the set of candidate contributors can represent a subset of the input elements 106 determined to have a sufficiently high similarity score (e.g., over a threshold), or within a threshold percentile of ranked semantic similarity to the target element 113.

The prompt parser 120 is a module for reconfiguring the prompt 104 input into the LLM to generate additional summaries 110. For instance, the prompt parser 120, to test for contributors among the set of candidate contributors, can remove candidate contributors (i.e., the corresponding input elements) from the set of input elements 106 to generate reduced, test prompts that are input into the LLM 102 to generate corresponding summaries 110. Additional operations of the prompt parser 120 are discussed with respect to the operations of FIGS. 2 and 3.

To further identify contributors, the contributor identifier module 118 can communicate with a classifier module 122. The classifier module 122 is configured to determine an entailment or contradiction score based on the target element 113 compared against a given prompt 104 as generated by the prompt parser 120. The classifier module 122 can be an NLI classification model used to evaluate the similarity between a generated summary and the target element. The NLI classification model can provide Zero Shot text classification. Additional operations of the classifier module 122 are discussed according to the operations of FIGS. 2 and 3.

### Example Process for LLM Explainability

FIG. 2 shows an example process for explaining LLM output based on identifying contributor inputs, according to certain examples. For illustrative purposes, the process 200 is described with reference to implementations described above with respect to one or more examples described herein. Other implementations, however, are possible. In some aspects, the operations in FIG. 2 may be implemented in program code that is executed by one or more computing devices such as the LLM analysis computing system 100 of FIG. 1. In some aspects of the present disclosure, one or more operations shown in FIG. 2 may be omitted or performed in a different order. Similarly, additional operations not shown in FIG. 2 may be performed.

At block 202 the process 200 involves receiving an input prompt including a set of input elements 106. Each input element of the set of input elements 106 can be a collection of text, for instance, each input element representing a sentence, phrase, paragraph, word, or the like. Thus, the prompt 104 includes a collection of text, such as sentences, described as input elements. The prompt 104 may be received from within the computing system, or upon a transmitted request (e.g., from a user interface 108).

At block 204 the process 200 involves applying the input prompt to an LLM 102 to generate a first summary including a set of generated elements. The first summary, like the prompt 104 received at block 202, includes a set of generated elements 112 where each element can be a collection of text such as sentences, phrases, paragraphs, words and the like. It should be appreciated that the summary need not be limited to summarizing the input prompt and can more generally represent any collection of text generated by the LLM in response to the input prompt having been input into the LLM.

At block 206 the process 200 includes identifying a target element 113 within the set of generated elements 112. The target element 113 can represent a specific portion of text (e.g., a sentence) within the summary 110 that is to be explained. The target element may for instance be a hallucination identified by a user with access to LLM analysis computing system 100.

At block 208 the process 200 determines a similarity score for each input element, the similarity score representing a strength of similarity between the input element and the target element. To determine the similarity scores, each input element of the set of input elements 106 can be converted into embedding format, for instance via transformer 114. The target element 113 can similarly be converted into an embedding format within an embedding space. An embedding comparator 116 can then be applied to each of the input elements and the target element within the embedding space to determine a similarity score, or semantic similarity between each input element 106 and the target element. The embedding comparator 116 may for instance include a cosine similarity function, mapping the similarity between each input element of the set of input elements 106 and the target element 113.

At block 210 the process 200 includes identifying a set of candidate contributor elements among the set of input elements based on the similarity score for each input element of the set of input elements. The candidate contributor elements represent elements within the set of input elements that are deemed likely to cause the LLM to generate the target element 113. A contributor identifier module 118, choosing the candidate contributor elements based on the ranked similarity scores can thus provide an initial means of reducing the overall size of the candidate contributor elements in an optimal manner.

The size of the candidate contributor set (referred to as “n”) represents a tunable hyperparameter in the explainability process. For instance, a larger size n leads to a greater inclusion of candidate contributors, which can assist in more accurately scanning the overall set of input elements 106 for the contributor elements causing the generation of the target element 113. However, a larger size n can further introduce noise as well as computing expenditures. Thus, the candidate contributor set size can be tuned according to the compute power and demands for accuracy according to a variety of implementations.

At block 212 the process 200 includes generating a reduced prompt including a subset of the input elements lacking the set of candidate contributor elements. The reduced prompt otherwise retains each of the input elements 106 including the input prompt, except the set of candidate contributor elements. By leaving out the set of candidate contributors, the LLM analysis computing system 100 can evaluate the significance of the candidate contributor set per blocks 214 and 216.

At block 214 the process 200 involves applying the reduced prompt to the LLM 102 to generate a second summary including a set of second generated elements. The second summary may or may not have substantial similarity to the original summary generated by applying the input prompt to the LLM 102. Rather, absence of one or more of the candidate contributors may cause sufficient dissimilarity (i.e., a contradiction), indicating that the candidate contributor is an actual contributor, such that inclusion of the corresponding input element caused the generation of the target element on initial input of the input prompt into the LLM 102.

At block 216 the process 200 involves, in response to determining the second summary contradicts the target element, identifying one or more candidate contributor elements of the set of candidate contributor elements as contributor elements. To determine contradictions between the second summary and the target element, a classifier module 122 such as an NLI classifier can be applied. The second summary is used as the premise and the target element is used as the hypothesis. The classifier can generate a contradiction score indicative of the degree to which the second summary contradicts the target element. If the contradiction score exceeds a threshold value, the second summary is determined to contradict the target element. The contradiction would thus indicate that the absence of one or more candidate contributor elements caused the contradiction, identifying the candidate contributor elements under test as contributor elements.

### Example Process Denoising Identified Contributors

The process 200 described above provides an example means by which the LLM analysis computing system 100 can identify contributor elements within a given prompt which cause the LLM to generate a target element within a summary. However, merely identifying the candidate contributor set, as a whole, as having contributors within the set may lack precision and may include noise. Therefore, a further process may be employed by the LLM analysis computing system 100 to identify, within the candidate contributor set, specific candidate contributors as contributors, causing the generation of the target element 113.

FIG. 3 shows an example process for denoising contributor inputs to improve LLM explainability, according to certain examples. For illustrative purposes, the process 300 is described with reference to implementations described above with respect to one or more examples described herein. Other implementations, however, are possible. In some aspects, the operations in FIG. 3 may be implemented in program code that is executed by one or more computing devices such as the LLM analysis computing system 100 of FIG. 1. In some aspects of the present disclosure, one or more operations shown in FIG. 3 may be omitted or performed in a different order. Similarly, additional operations not shown in FIG. 3 may be performed.

At block 302 the process 300 involves, for each candidate contributor, generating a size 1 test prompt, where the size 1 test prompt includes each input element except the candidate contributor. Thus, the prompt parser 120 can iteratively generate test prompts where each prompt includes every input element of an input prompt, except for a respective candidate contributor. As per FIG. 2, the contributor identifier can identify the initial set of candidate contributors as sufficiently semantically similar per the embedding comparator 116.

At block 304 the process 300 involves, for each size 1 test prompt, generating a corresponding summary, and determining whether the corresponding summary contradicts the target element. As per other examples, generating the corresponding summary includes applying each size 1 test prompt into the LLM 102 to produce the corresponding summary, where the corresponding summary includes a set of generated elements.

At block 306 the process 300 involves, in response to determining the corresponding summary contradicts a target element, identifying the respective candidate contributor as a contributor element. Contradiction between the corresponding summary and the target element is determined similar to block 216, where a classifier is applied to the corresponding summary and the target element, and a contradiction score generated indicating the strength of the relationship between the corresponding summary and the target element. If the contradiction score exceeds a given threshold, then a determination is made that the corresponding summary contradicts the target element. The contradiction therefore indicates the corresponding candidate contributor is an actual contributor. As blocks 302-306 relate to size 1 test prompts, where candidate contributors are discretely tested, the candidate contributor determination per block 306 identifies a specific element within the input prompt (e.g., a sentence) that explains the generation of the target element in the generated summary. The identified candidate contributors may then be removed from the set of candidate contributors to facilitate additional searching of the remaining, undecided elements left in the input prompt.

At block 308 the process 300 involves, for each remaining candidate contributor, generating candidate contributor pairs. Candidate contributor pairs can be generated for all combinations of the remaining candidate contributors.

At block 310 the process 300 involves, for each candidate contributor pair, generating a size 2 test prompt, where the size 2 test prompt includes each input element except the candidate contributor pair. Block 310 follows a similar procedure to block 302, where, for each candidate contributor pair, a size 2 test prompt is generated. The size 2 test prompt includes each input element except the candidate contributor pair.

At block 312 the process 300 involves, for each size 2 test prompt, generating a corresponding summary, and determining whether the corresponding summary contradicts the target element. As per other examples, generating the corresponding summary includes applying each size 2 test prompt into the LLM 102 to produce the corresponding summary, the corresponding summary including a set of generated elements.

At block 314 the process 300 involves, in response to determining the corresponding summary contradicts the target element, identifying the respective candidate contributor pair as a contributor pair. Block 314 is similar to block 306, where the classifier module 122 is employed to identify contradictions between each test prompt and the target text, where identifying a contradiction identifies the corresponding candidate contributor pair as a contributor pair. In some examples, each member of the candidate contributor pair may then be removed from the remaining set of candidate contributors to further reduce the set of candidate contributors before further iterating in a subsequent stage.

Blocks 302-306 and 308-314 are the first two stages of a recursive process where the set of candidate contributors is searched in an optimized order, beginning with a size 1 test per blocks 302-306, then subsequently testing pairs of candidate contributors per a size 2 test. The process may be iterated into size n tests, where in a size n=3 test, candidate contributor triplets are tested by removing triplets of candidate contributors from the set of candidate contributors. Thus, the process can proceed for any arbitrary size of n. However, at a certain stage of process 300, the undecided candidates will be exhausted. Thus, an exit condition may be imposed. At block 316 the process 300 involves iterating testing until the test prompt size is greater than (or in some cases, merely equal to) the number of remaining candidate contributors. Thus, iterating testing can include iteratively testing in a manner similar to blocks 302-306 and 308-314 by increasing test size n until the target size (e.g., size n) is greater than the number of undecided elements left in the set of candidate contributors.

### Example Computing Environment for an LLM Explainability System

Any suitable computing system or group of computing systems can be used for performing the operations described herein. For example, FIG. 4 shows a block diagram for an example computing environment capable of executing the described systems and methods, according to certain examples.

The depicted example of a computing system 402 includes one or more processors 406 communicatively coupled to one or more memory devices 404. The processor 406 executes computer-executable program code or accesses information stored in the memory device 404. Examples of processor 406 include a microprocessor, an application-specific integrated circuit (“ASIC”), a field-programmable gate array (“FPGA”), or other suitable processing device. The processor 406 can include any number of processing devices, including one.

The memory device 404 includes any suitable non-transitory computer readable medium for storing prompt parser module 422, contributor identification module 424, contradiction classifier 426, and other dynamic instructions 428 or received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 402 may also include a number of external or internal devices such as input or output devices. For example, the computing system 402 is shown with an input/output (“I/O”) interface 410 that can receive input from the input devices or provide output to output devices. A bus 408 can also be included in the computing system 402. The bus 408 can communicatively couple one or more components of the computing system 402.

The computing system 402 executes program code that configures the processor 406 to perform one or more of the operations described above with respect to FIGS. 1-3. The program code includes operations related to, for example, receiving and ingesting data files, generating metadata associated with the data files, and determining access to the data files, or other suitable applications or memory structures that perform one or more operations described herein. The program code may be resident in the memory device 404 or any suitable non-transitory computer-readable medium and may be executed by the processor 406 or any other suitable processor. In some examples, the program code described above, including prompt parser module 422, contributor identification module 424, contradiction classifier 426, and other dynamic instructions 428 or received or determined values or data objects are stored in the memory device 404, as depicted in FIG. 4. In additional or alternative examples, one or more of the prompt parser module 422, contributor identification module 424, contradiction classifier 426, and other dynamic instructions 428 or received or determined values or data objects described above are stored in one or more memory devices accessible via a data network, such as a memory device accessible via a cloud service.

The computing system 402 depicted in FIG. 4 also includes at least one network interface 412. The network interface 412 includes any device or group of devices suitable for establishing a wired or wireless data connection to one or more data networks 414. The computing system 402 can communicate, via the one or more data networks 414, with viewing applications 420, including user interfaces. Non-limiting examples of the network interface 412 include an Ethernet network adapter, a modem, and/or the like. A remote communication service 418 is connected to the computing system 402 via network 414 and can perform some of the operations described herein including generating templates or receiving messaging data and applying the messaging data to a specified template. The computing system 402 is able to communicate with one or more of the remote communication service 418 and data sources 416.

### Advantages of Systems and Methods for LLM Explainability

The described systems and methods provide improvements to large language model implementation by providing techniques for identifying and explaining how an LLM generates outputs. The described techniques address means for isolating the root cause of inefficiencies within LLMs, such as hallucinations generated by the LLM, by providing a procedural mechanism for testing LLM inputs compared against a target output, such as the hallucination. Practicing the described techniques allows users to fine tune the implementation of LLMs and identify potential failure points, within the input, or within the LLM itself. Such improvements to LLMs are necessarily integrated within computing systems and necessarily improve computer functionality by improving the operation of LLMs.

Additionally, the described techniques address optimized means for testing LLMs in a manner that allows for increased efficiencies in the underlying hardware implementing the LLM analysis. Compared to past techniques for attempting LLM analysis and explanation, the described techniques provided improved efficiencies in compute speed and reduced computational costs. As described, the search space of candidate contributors is initially determined based on semantic similarity, thereby reducing the candidate search space greatly in an initial stage. Additionally, an optimized noise filtration protocol is discussed which methodically and efficiently identifies contributor elements within an input prompt that cause the generation of a target element. The optimized noise filtration protocol proceeds in a manner that reduces the computational costs of evaluating the significance of given elements within an input prompt. Compared to prior techniques, the described procedures thus provide an improvement to computer functionality by enhancing computer processor resource utilization.

### GENERAL CONSIDERATIONS

Although the subject matter has been described in language specific to structural features or methodological acts, it is to be understood that the subject matter of any appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or any claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving an input prompt comprising a set of input elements;
applying the input prompt to a large language model (LLM) to generate a first summary;
identifying a target element within the first summary;
determining a similarity score for each input element of the set of input elements;
identifying a set of candidate contributor elements among the set of input elements;
generating a reduced prompt comprising a subset of the input elements;
applying the reduced prompt to the LLM to generate a second summary; and
identifying a candidate contributor element.

2. The method of claim 1, further comprising:
for each candidate contributor, generating a size 1 test prompt;
for each size 1 test prompt, generating a corresponding summary; and
in response to determining the corresponding summary contradicts a target element, identifying a respective candidate contributor element as a contributor element.

3. The method of claim 2, further comprising:
removing the contributor element from the set of remaining candidate contributors.

4. The method of claim 3, further comprising:
for each remaining candidate contributor, generating candidate contributor pairs;
for each candidate contributor pair, generating a size 2 test prompt;
for each size 2 test prompt, generating a corresponding summary; and
in response to determining the corresponding summary contradicts the target element, identifying the respective candidate contributor pair as a contributor pair.

5. The method of claim 4, further comprising:
iterating testing until the size of the test prompt is greater than the number of remaining candidate contributors.

6. The method of claim 4, further comprising:
iterating testing until the size of the test prompt is equal to the number of remaining candidate contributors.

7. The method of claim 1, wherein the similarity score represents a strength of similarity between the input element and the target element.

8. The method of claim 1, wherein determining the similarity score includes determining a cosine similarity between an embedding representation of the input element and an embedding representation of the target element.

9. The method of claim 1, wherein the reduced prompt includes a subset of the input elements lacking the set of candidate contributor elements.

10. The method of claim 1, wherein each element of the set of input elements comprises a sentence.

11. A system comprising:
a memory component; and
a processing device coupled to the memory component, the processing device to perform operations comprising:
receiving an input prompt comprising a set of input elements;
applying the input prompt to a large language model (LLM) to generate a first summary;
identifying a target element within the first summary;
determining a similarity score for each input element of the set of input elements;
identifying a set of candidate contributor elements among the set of input elements;
generating a reduced prompt comprising a subset of the input elements;
applying the reduced prompt to the LLM to generate a second summary; and
identifying a candidate contributor element.

12. The system of claim 11, wherein the operations further comprise:
for each candidate contributor, generating a size 1 test prompt;
for each size 1 test prompt, generating a corresponding summary; and
in response to determining the corresponding summary contradicts a target element, identifying a respective candidate contributor element as a contributor element.

13. The system of claim 12, wherein the operations further comprise:
removing the contributor element from the set of remaining candidate contributors.

14. The system of claim 13, wherein the operations further comprise:
for each remaining candidate contributor, generating candidate contributor pairs;
for each candidate contributor pair, generating a size 2 test prompt;
for each size 2 test prompt, generating a corresponding summary; and
in response to determining the corresponding summary contradicts the target element, identifying the respective candidate contributor pair as a contributor pair.

15. The system of claim 14, wherein the operations further comprise:
iterating testing until the size of the test prompt is greater than the number of remaining candidate contributors.

16. The system of claim 14, wherein the operations further comprise:
iterating testing until the size of the test prompt is equal to the number of remaining candidate contributors.

17. The system of claim 11, wherein the similarity score represents a strength of similarity between the input element and the target element.

18. The system of claim 11, wherein determining the similarity score includes determining a cosine similarity between an embedding representation of the input element and an embedding representation of the target element.

19. The system of claim 11, wherein the reduced prompt includes a subset of the input elements lacking the set of candidate contributor elements.

20. A non-transitory computer-readable medium storing executable instructions, which when executed by a processing device, cause the processing device to perform operations comprising:
receiving an input prompt comprising a set of input elements;
applying the input prompt to a large language model (LLM) to generate a first summary;
identifying a target element within the first summary;
determining a similarity score for each input element of the set of input elements;
identifying a set of candidate contributor elements among the set of input elements;
generating a reduced prompt comprising a subset of the input elements;
applying the reduced prompt to the LLM to generate a second summary; and
identifying a candidate contributor element.
